(19) United States
(12) Patent Application Publication
(10) Pub. No.: US 2018/0205292 A1
(43) Pub. Date: Jul. 19, 2018

(54) MOTOR FORCIBLY COOLING DEVICE WITH REAR DRIVE ASSEMBLY

(71) Applicant: HEADLINE ELECTRIC CO., LTD., NAN TOU HSIEN (TW)

(72) Inventors: KAO-JUNG LEE, NAN TOU HSIEN (TW); CHIU-YAO LIN, NAN TOU HSIEN (TW); CHIH-YUNG LI, NAN TOU HSIEN (TW)

(21) Appl. No.: 15/407,263

(22) Filed: Jan. 17, 2017

(51) Int. Cl. H02K 9/06

(52) U.S. Cl. CPC H02K 9/06

(57) ABSTRACT

A motor forcibly cooling device with a rear drive assembly includes a motor body and a motor rotating shaft extended out from a center thereof toward one side or two sides thereof, another end of the motor body being assembled with a annular frame to form a covering space allowing a drive and cooling plate to be mounted therein, where the motor rotating shaft is extended out of a through hole configured on a center of the cooling plate to assemble a leaf group on the motor rotating shaft directly, allowing the leaf group to be rotated with the motor, a windshield is configured outside the leaf group to cover a connection of the leaf group with annular frame, allowing the leaf group to cool forcibly the cooling plate and a peripheral face of the motor body through a wind direction guiding covering edge face of the windshield.

### (a) TECHNICAL FIELD OF THE INVENTION

The present invention relates to a motor forcibly cooling device with a rear drive assembly, achieving the operation of a motor being blown and cooled synchronously with a drive, allowing long-term practical and safe operation control over a motor structure assembly by assembling a synchronously turned fanning and cooling leaf group on a motor rotating shaft outside the drive, and making it operated in coordination with the wind direction guided by a windshield covered thereon.

### (b) DESCRIPTION OF THE PRIOR ART

On the motor structure connection use of conventional brushless motor with a rear drive assembly, for practical drive cooling and the requirement of long-term operation control, a patent such as Taiwan patent No. 1335124, titled “SELF-COOLING BACK-CONNECT DRIVER MOTOR ASSEMBLY”, allows the rotating(rotating) of a motor to synchronously achieve the internal fanning and cooling of a drive through a built-in centrifugal fan, and with a venting hole device configured on the drive housing, achieve inside and outside cold and hot air convection, thereby cooling the motor. However, the patent mainly provides forced air circulation to dissipate heat generated from the drive assembly so as to avoid the influence to the operation of the motor, but the entire structural design thereof is installing the centrifugal fan inside the drive assembly, air being blown from inside to outside, and cold and hot air only can be convected through the venting hole device such that the air circulation effect is very poor, and the drive assembly is always in a hot box-like heating situation because the whole cooling operation is not smooth, which not only affect the long-term use of the drive, but merely allow the entire cooling operation to only improve the cooling of the drive without any effect on the cooling of the motor. In addition, the venting hole device being configured on the drive housing may further possibly cause external dust and the like to fall inside the drive, resulting in use and control security concerns, and unable to cool the entire motor; the entire cooling capable of the cooling assembly is insufficient even if cooling fins are configured on the drive additionally for auxiliary cooling.

### SUMMARY OF THE INVENTION

To overcome the defects mentioned above, the present invention is proposed.

The main object of the present invention is to provide a motor forcibly cooling device with a rear drive assembly, extending a motor rotating shaft out of a cooling plate of the drive assembly to assemble with a rotating leaf group, allowing it to be rotate with the motor to do fanning, and with a windshield guiding wind, the wind is blown to the peripheral of the motor, thereby achieving the forced cooling of the drive and motor.

To achieve the object mentioned above, the present invention proposes a motor forcibly cooling device with a rear drive assembly, including a motor body and a motor rotating shaft extended out from a center thereof toward one side or two sides thereof, another end of the motor body being assembled with a annular frame to form a covering space allowing a drive and cooling plate to be mounted therein, thereby forming a complete motor structure with the drive, wherein the motor rotating shaft is extended out of a through hole configured on a center of the cooling plate to assemble a leaf group on the motor rotating shaft directly, allowing the leaf group to be rotated with the motor, an inverted “U”-shaped windshield is configured outside the leaf group to cover a connection of the leaf group with annular frame, allowing the leaf group to fan and cool forcibly the cooling plate and a peripheral face of the motor body through a wind direction guiding covering edge face of the windshield when rotated with the motor.

### BRIEF DESCRIPTION OF THE DRAWINGS

FIG. 1 is an exploded view of a motor structure assembly of the present invention;

FIG. 2 is a perspective view of the motor structure assembly of the present invention;

FIG. 3 is a perspective view of a cooling windshield of assembly on a motor according to the present invention; and

FIG. 4 is a cross-sectional view of a motor assembly of the present invention where cooling wind directions are shown as arrows.

### DETAILED DESCRIPTION OF THE PREFERRED EMBODIMENTS

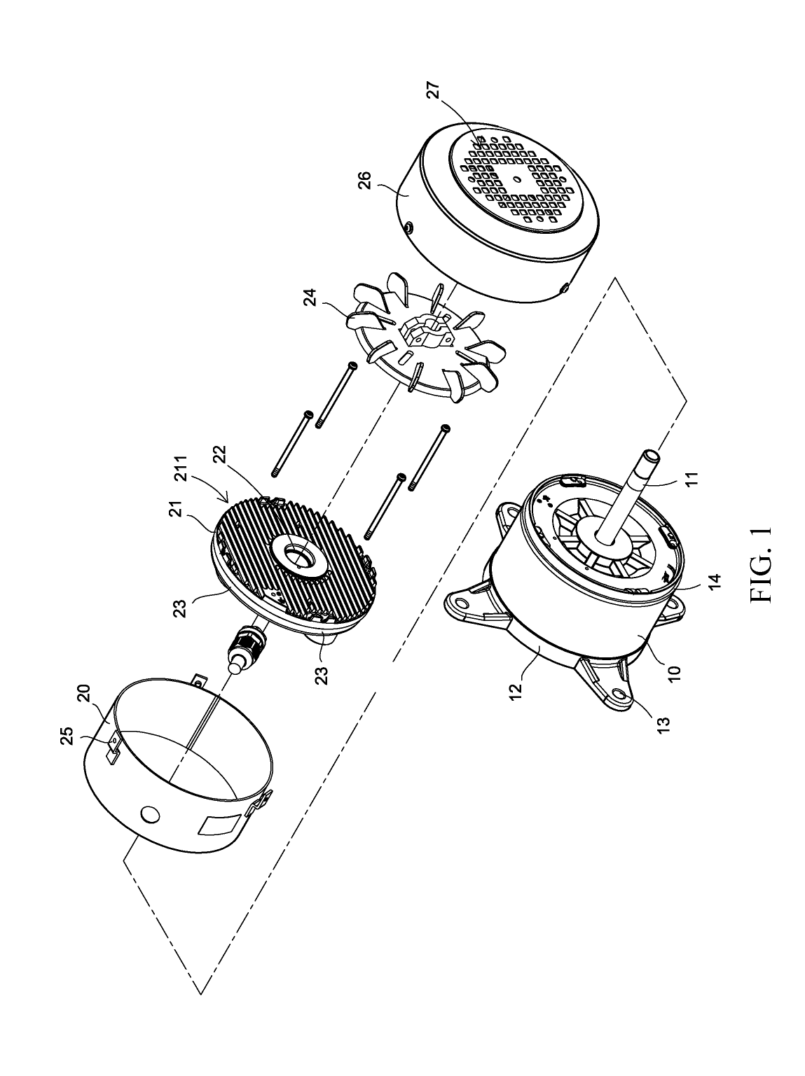

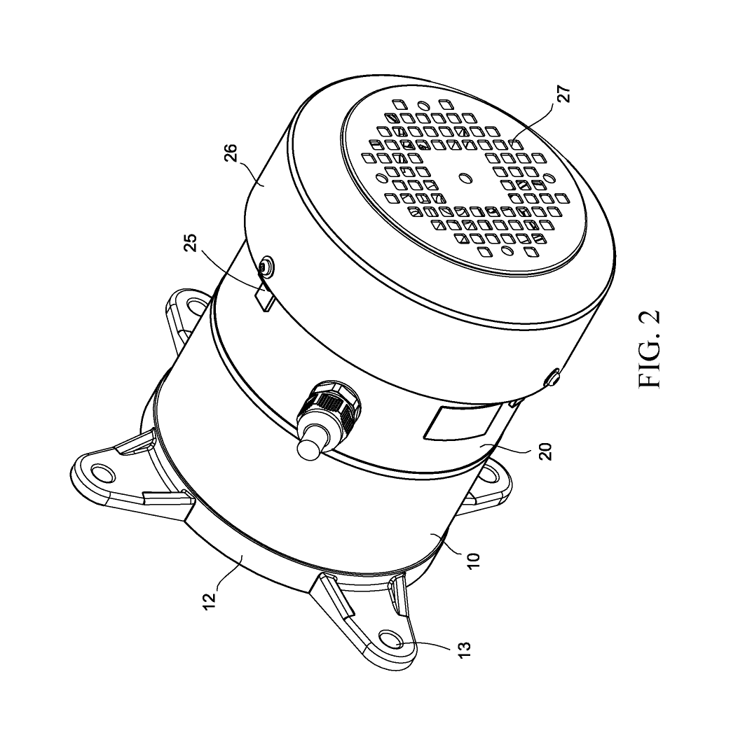

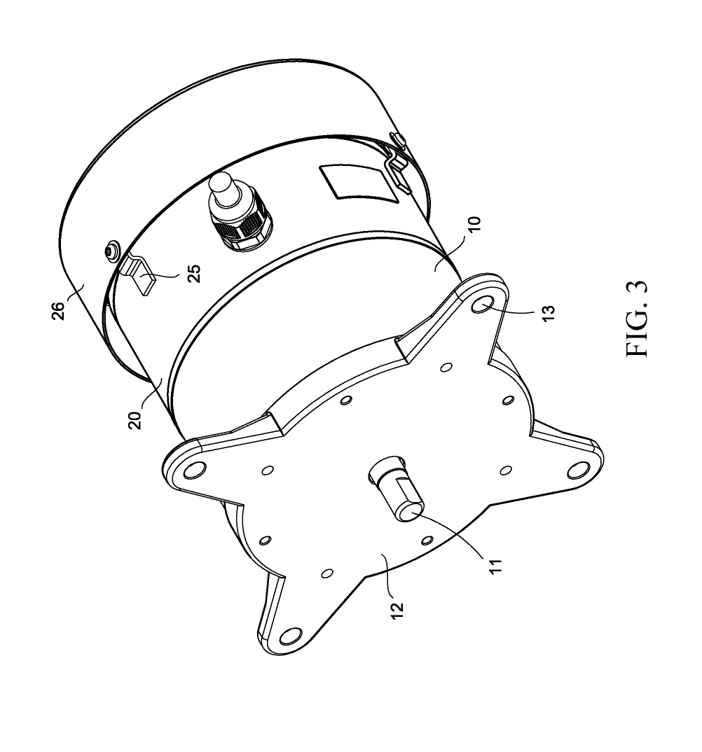

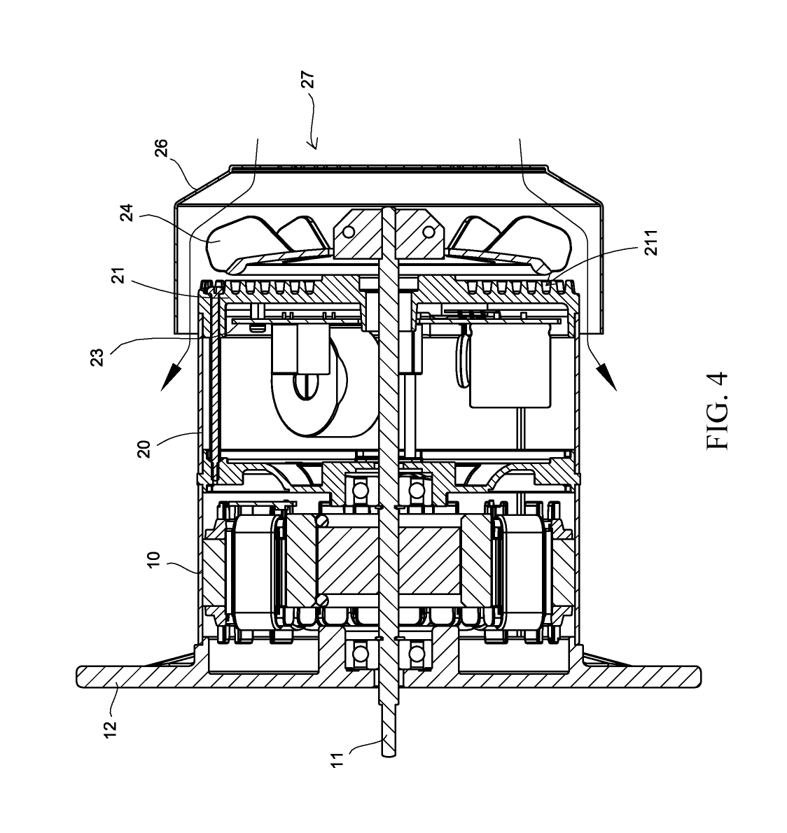

A motor forcibly cooling device with rear drive assembly, as shown in FIGS. 1 to 4, includes a motor body 10 and a motor rotating shaft 11 extended from the center of the motor body 10 toward one side or two sides thereof, where a plurality of locking hole seats 13 are equally spaced around an end plate 12 configured on one side of the motor body 10, allowing the entire motor assembly structure to be fixed, and an annular frame 20 is put around a stepped ring 14 configured on one end edge of the motor body 10, the annular frame 20 having a proper length allowing a covered space to be formed between it and the motor. Furthermore, a cooling plate 21 made of a metal plate is inserted in the opening end of the annular ring 20, and the outer side end face of the cooling plate 21 is formed into a concave convex fm-like cooling curved face with a larger heat dissipation area and the center thereof a through hole 22 allowing the motor rotating shaft 11 to be passed through and extended out, where the inner plate of the cooling plate 21 is assembled and positioned with a drive 23, and the peripheral face thereof is further sealed properly with glue for moisture-proof purpose, achieving a safety and waterproof assembly. Furthermore, a through hole corresponding to the central through hole 22 of the cooling plate 21 is configured on the plate face of the drive 23, a leaf group 24 used as a fan is configured on the extended-out rotating shaft 11 outside the central through hole 22 of the cooling plate 21, thereby allowing it to be rotated with the motor rotating shaft 11 to increase the cooling speed of the cooling curved face 211 of the cooling plate 21 of the driving device. Furthermore, an inverted “U”-shaped windshield 26 is mounted on a plurality of foot pieces spaced equidistantly on the peripheral of the annular ring 20, covering the entire rotatable leaf group 24 directly, allowing it to cover the location of the cooling plate 21 attached to the annular frame 20, where a through hole face 27 for air intake is configured on the bottom end face of the windshield 26, allowing the leaf group 24 to be rotated synchronously with the started motor to fan and cool the cooling plate 21 directly, and the wind to flow along the covering edge face of the windshield 26 to assist blowing of cooling air from the peripheral of the annular frame 20 to the peripheral face of the motor body 10, allowing the leaf group 24 to be rotated with the motor when started to carry out forced blowing of cooling air to the peripheral of the motor body 10 synchronously through the wind direction guidance of the windshield 26, thereby preventing the motor body 10, drive 23 and other devices from being overheated, and achieving the safe use of the motor upon rotation.

The brushless motor cooling structure with drive device of the present invention is mainly characterized in that the leaf group 24 being assembled on a proper length of the motor rotating shaft 11 extended out the cooling plate 21 of the drive 23 allows it to rotated with the motor, achieving the fanning operation. With the windshield 26 covering the leaf group 24 with a proper spacing, the entire outlook is flat and neat and the rotation safety is ensured. Furthermore, the through hole face 27 for air inlet being configured on the center of the windshield 26 and the fanning generated from the rotation of the leaf group speed the cooling of the cooling plate 21. In addition, the space between the windshield 26 with a larger diameter and annular frame 20 guides wind to the motor body 10, achieving the forced blowing of cooling air to motor body 10 upon the rotation thereof, ensuring the operating(operating) control safety of the motor. The present invention is simple in assembly and has the practical effect of synchronous blowing and forced cooling.

I claim:

1. A motor forcibly cooling device with a rear drive assembly, comprising a motor body and a motor rotating shaft extended out from a center thereof toward one side or two sides thereof, another end of said motor body being assembled with a annular frame to form a covering space allowing a drive and cooling plate to be mounted therein, thereby forming a complete motor structure with said drive, wherein said motor rotating shaft is extended out of a through hole configured on a center of said cooling plate to assemble a leaf group on said motor rotating shaft directly, allowing said leaf group to be rotated with said motor, an inverted “U”-shaped windshield is configured outside said leaf group to cover a connection of said leaf group with annular frame, allowing said leaf group to fan and cool forcibly said cooling plate and a peripheral face of said motor body through a wind direction guiding covering edge face of said windshield when rotated with said motor.

2. The device according to claim 1, wherein a through hole face for air inlet is configured on a bottom end face of said inverted “U” shaped windshield.

3. The device according to claim 1, wherein a plurality of fixing hole seats are configured on a side end plate of said motor body.
